(19) United States
(12) Patent Application Publication
(10) Pub. No.: US 2011/0016792 A1
(43) Pub. Date: Jan. 27, 2011

(54) DRIP CAP WITH DISCHARGE ADAPTATION TO PROTECT BUILDING OPENINGS AND THEIR INTERIOR FROM DIRECT SOLAR RADIATION REFLECTED FROM ITS SURFACE

(75) Inventor: Antonio Verd Herrero, Madrid (ES)

Correspondence Address: MERCHANT & GOULD PC, P.O. BOX 2903, MINNEAPOLIS, MN, 55402-0903, US

(73) Assignee: UNIVERSIDAD POLITECNICA DE MADRID, Madrid (ES)

(21) Appl. No.: 12/599,381

(22) PCT Filed: May 7, 2008
(86) PCT No.: PCT/ES2008/000316

§ 371 Date: Oct. 18, 2010

(30) Foreign Application Priority Data
May 9, 2007 (ES) P2007 A 1255

(51) Int. Cl. E06B 7/00

(52) U.S. Cl. 49/70

(57) ABSTRACT

It is a drip cap which works as a passive, eco-efficient and sustainable system to optimize and harness architectural resources, through the adaptation of inclined plane slopes, replacing their function of drip caps and turning them into surfaces which reflect undesired direct solar radiation, so that they contribute to low power consumption during warm months in massive building. It shields the interior from solar incidence and reduces energy flow through the enclosure openings, reducing heat gain, accumulation and penetrations by conduction and reflected radiation, suppressing a traditional heat bridge.

### TECHNICAL FIELD

This invention refers to the technical field of construction (sites, heating and ventilation installations), involving the energy sector.

### STATE OF THE ART

The new invention refers to an aspect which has been barely contemplated so far, since slopes are traditionally formed with the sole purpose of enabling water to be discharged.

It solves the technical problem of fulfilling a function and adding a service to save energy through a passive and sustainable system. Besides, this does not interfere with the existing functions and services, since its new configuration—greater slope—, further facilitates water discharge.

It is novel because it represents a radical change of criterion for the arrangement of enclosure crowning parts and elements, mainly in openings where solar radiation penetrates (windows), in building, construction in general and related uses. It generically and massively affects an aspect which is little contemplated in traditional construction (the most extensive and constant in this productive sector) when dealing with established uses, practices and habits which need to be renovated vis-à-vis the eco-efficient and sustainable future.

In most of the existing inventions related to solar radiation, there are contemplated systems for power collection. There are also blinds, awnings and brise-soleil, in general, adopted to achieve climatic comfort by means of shadow. However, the characteristic of this procedure is the discharge (or deviation) of radiation, through reflection. This means the revision of an important aspect—the reflected radiation, conducted and transmitted through constructive plans—, relevant for energy saving, thanks to its sustainable nature. Its interest lies in the fact that it adds a new consideration to an already-existing part, element or system which has been disregarded, in the field of building, construction in general and related uses.

It is possible to cite patents related to the invention: Portable device for localized solar radiation ES 2 221 789 A1 and others related in general to solar radiation, such as: ES 2 107 253 T3; ES 2 105 769 T3; ES 2 207 280 T3; ES 2 202 430 T3; ES 2 201 332 T3; ES 2 196 771 T3; ES 2 185 312 T3; ES 2 182 581 T3; ES 2 164 638 T3.

### DETAILED DESCRIPTION OF THE INVENTION

The invention pursues a new radiation-reflecting utility in facade elements, crowning parts in windowsills and openings, traditionally executed with rain slope, so far disregarded as intervening factors for thermal effects in order to optimize and harness the architectural resources in buildings, as a consequence of the upcoming climatic change.

This entails a revision of functions and services in horizontal or little inclination surfaces (drip caps, coping, cornices, terraces), where the incidence and reflection of solar radiation during warm months is close to the vertical.

It focuses on a problem found in the most insolated building areas vulnerable to thermal transfer since it is through the enclosure openings that there is more energy flow, with heat gain/loss, accumulation and penetration by conduction and reflected radiation, constituting a traditional heat bridge.

It is conceived as a protection for openings against the incidence of direct solar radiation towards the outside during warm months, through a process of drip cap slope adaptation in building windows and similar inclined planes, and their materialization, according to their situation and orientation.

It is intended to be incorporated as part of the passive, eco-efficient and sustainable system, characterized by the adaptation of inclined plane slopes, replacing their function of drip caps and turning them into surfaces which reflect undesired direct solar radiation, so that they contribute to low power consumption during warm months.

It has an extensive and generic effect on a problem traditionally established in massive construction.

### BRIEF DESCRIPTION OF THE DRAWINGS

FIG. 1 represents a perspective sectional view of the invention in a building window, with a slope according to its situation and orientation, to protect against the incidence of direct solar radiation, reflecting it towards the outside during warm months, where (1) is the existing traditional drip cap on the basis of the window opening, (2) is the brick facade enclosure, (3) is the window glass, (4) is the blind track, (5) is the reflecting slope with folded metallic sheet, and (6) is the body of the drip cap constituted by an insulating material (extruded polystyrene or alike).

FIG. 2 is a plan view and sectional scheme of the direct solar radiation affecting the façade west-oriented opening (window), in a place close to Madrid, according to the position of the sun on 1 Aug. 2006, at 19.45 official local time, for the slope adaptation corresponding to the prototype carried out, being the altazimuth coordinates: Altitude: 18.8°-Azimuth: 277.9.

FIG. 3 is a sectional view of the drip cap on an open west-oriented window (direct solar radiation incidence with an azimuth between 197.5° and)287.5° where it is possible to see the slope calculated according to its situation and orientation, to protect from the incidence of direct solar radiation, reflecting it to the outside during warm months.

FIG. 4 represents the plan view of the building orientation and the expression of the most characteristic azimuth coordinates to be considered for calculating the slope of the drip cap to be placed in window openings.

FIG. 5 is a plan and sectional schematic view considering the critical altitude of the sun for the east-oriented open window (direct solar radiation incidence with an azimuth between 107.5° and)197.5° where the calculation of the appropriate drip cap slope is graphically presented.

FIG. 6 represents a plan and sectional view of the graphic calculation of the drip cap slope on a west-oriented open window (direct solar radiation incidence with an azimuth between 197.5° and)287.5° according to another situation and orientation, to protect against the incidence of direct solar radiation, reflecting it to the outside during warm months, where (7) is the plan projection of the reflecting surface.

### DESCRIPTION OF AT LEAST ONE EMBODIMENT OF THE INVENTION

The embodiment is specific for a particular opening and their orientation. The procedure of configuration and calculation of the drip cap slope consists of heliocentrically considering the planetary and orbital movement of the building, locating it according to its geodesic position and, upon consideration of the altazimuth coordinates of the sun at a specific time of the year and at a specific time of the given day, obtaining these coordinates in the table provided, created from the data which have been announced [U.S. Naval Observatory. Astronomical Applications Department—adjusting the U.T.—, and MeteoGetafe] (TABLE 1, TABLE 2, TABLE 3 and TABLE 4, presented at the end of this section, where TABLE 1 contains Temperatures and altazimuth coordinates of the sun between 11.05 and 13.55, Madrid, Year 2006; TABLE 2: Temperatures and altazimuth coordinates of the sun between 14.00 and 16.55, Madrid, Year 2006; TABLE 3: Temperatures and altazimuth coordinates of the sun between 17.00 and 19.55, Madrid, Year 2006; and TABLE 4: Temperatures and altazimuth coordinates of the sun between 20.00 and 22.55, Madrid, Year 2006.

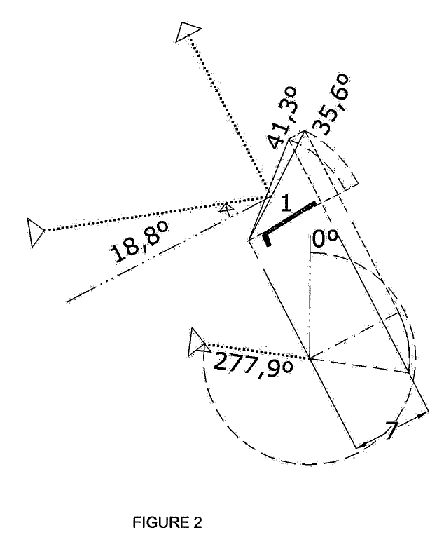

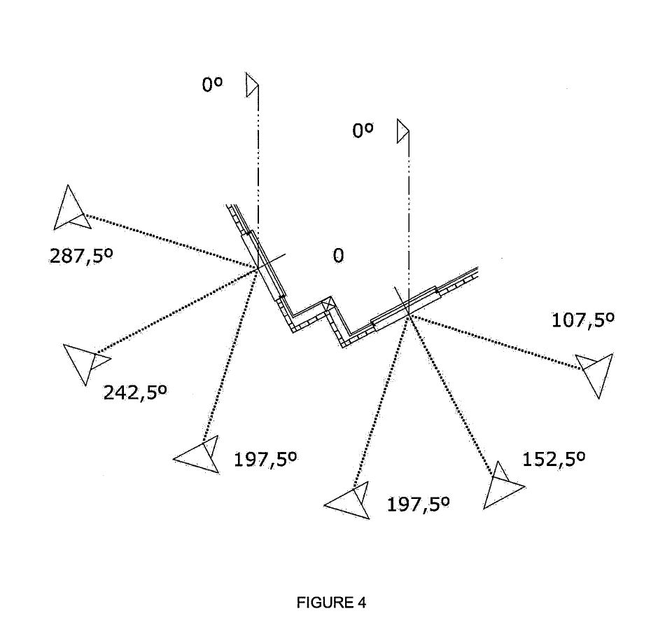

The calculation carried out using the graphic method (FIGS. 2, 5 and 6) considers the incidence of solar radiation in a 90° arch with three important radiation directions (normal and left and right bisecting lateral ones) according to the azimuth, centering the arch in front of each one of the openings, and starting in their axis of symmetry (FIG. 4), calculating the least favorable incidence according to its shortest (solar) altitude, and determining with it the adaptation of the slopes or discharges for the desired reflection.

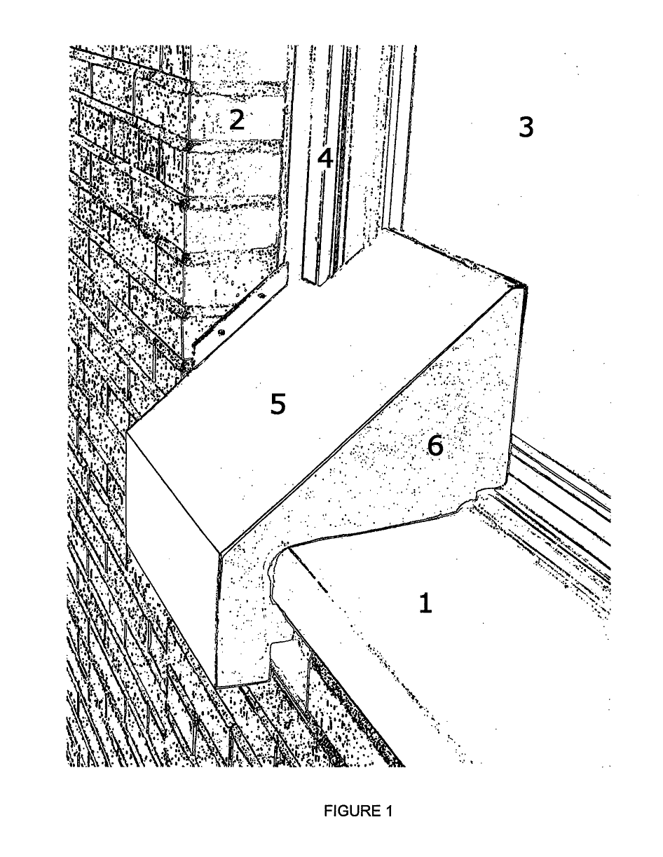

The invention has been carried out experimentally with the creation of a prototype. It comprises a metallic sheet skirt, forming the new reflecting slope (5), determined according to the aforementioned calculation. This sheet is folded and stiffened on itself, being it possible to house a body of insulation material inside it, to which it is attached, placing said body on top of the drip cap as wedge or boss (6). Being this part fixed to the opening base, it comprises protruding pins for its mechanical anchoring to both sides of the soffit, thus being incorporated to the building through this fastening (FIG. 1, 3). This incorporation can be permanent, as it works advantageously all year long, even in cold seasons, when there is less solar radiation and it is less high, and its heat effect is more comfortable. In this case, the inclined plane acts as reflecting surface directing solar radiation to the roof of the housing interior, improving its lighting.

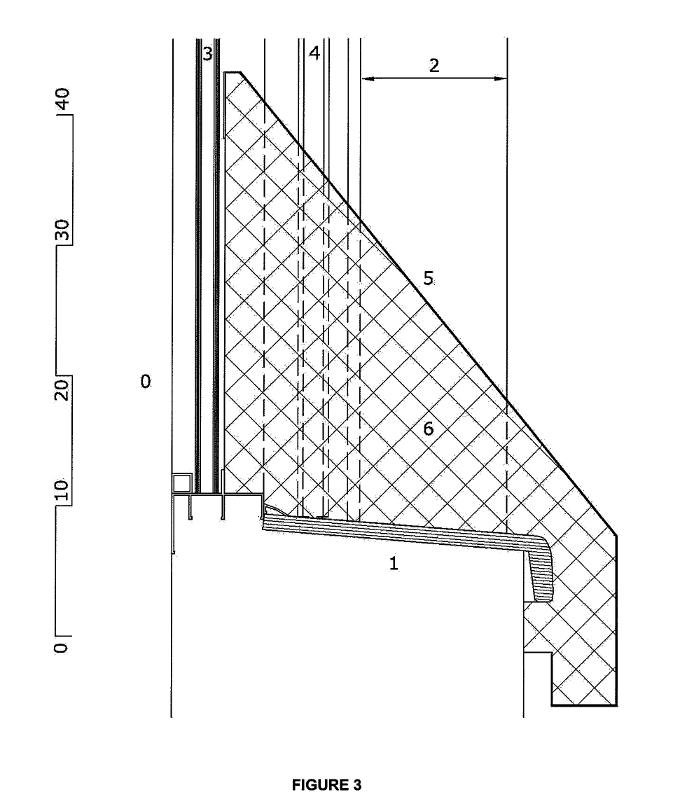

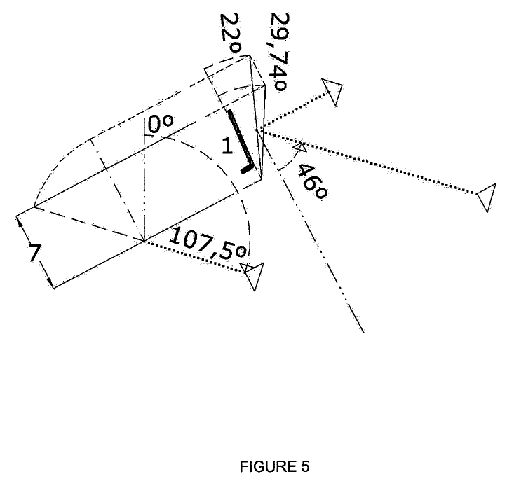

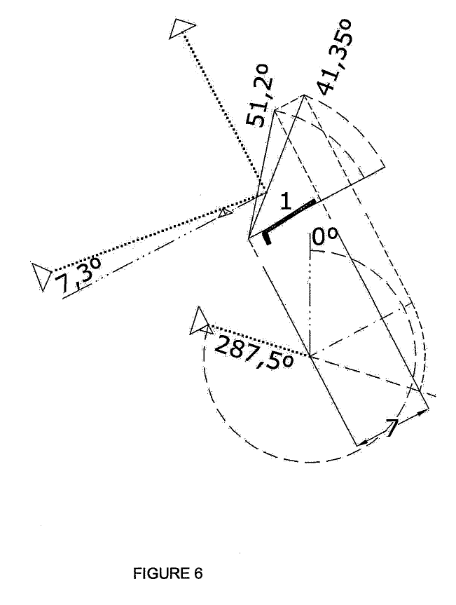

From the indicated orientation of Azimuth: 277.9 and Altitude: 18.8° (FIG. 4), it was obtained, by a geometrical construction (FIG. 2), the 41.3° slope to be given to the aforementioned prototype (FIG. 3), appropriate discharge of the base of the opening being considered. Thus, it is possible to avoid the reflection of the solar radiation incidence towards the inside on that plane. Other cases have also been calculated (FIGS. 5 and 6) in which the critical inclinations for azimuth angles of 107.5° (corresponding to the first bisecting line or 45° direction to the left looking through the east-oriented window) and 287.5° (corresponding to the second bisecting line or 45° direction to the right looking through the west-oriented window) have been geometrically calculated.

The prototype for the west-oriented window has been created only to cover until the time of excessive radiation. At 19.45, on 1 Aug. 2006, the room temperature was 34.5°. The sun coordinates at that moment were 277.9 azimuth and 18.8° Altitude. A drip cap inclination of 41.3° (FIGS. 2 and 3) corresponds to that in order to prevent the reflected radiation from penetrating the inside of the housing.

Indeed, the orientations, altazimuth angles, time and temperatures are different. Therefore, in order to prevent the reflection of the solar radiation incidence towards the inside of the housing, the (corrected) drip cap inclinations are different. Thus, the discharges in enclosure openings are different according to the building situation and orientation. In a new construction, it is applied to configure the different drip caps in a heliodynamic way, according to the orientation of the facades.

### INDUSTRIAL APPLICATION

It can be contemplated from three aspects:

a) In projects: Projected architecture for sustainability
b) In new constructions (new plan)
c) In already-existing constructions, restorations, reforms or renovations.

1. Drip cap with discharge adaptation to protect building openings and their inside against direct solar radiation reflected from its surface, wherein its outer face has a plane slope forming an angle symmetric to the incident radiation calculated so that it reflects it, heliocentrically considering the planetary and orbital movement of the building, its geodesic position and orientation and the altazimuth coordinates of the sun at a given time of the year and at a specific time of a given day.

2. Drip cap with discharge adaptation to protect building openings and their inside against direct solar radiation reflected from its surface, according to claim 1, wherein the theoretical or graphic calculation of the drip cap slope considers the solar radiation incidence in a 90° angle with three important directions (normal and bisecting lateral ones) according to the azimuth, centering said arch in front of each one of the openings, and starting at their axis of symmetry, calculating the least favorable incidence according to its shortest (solar) altitude, and determining with it the adaptation of the slopes or discharges for the desired reflection.

3. Drip cap with discharge adaptation to protect building openings and their inside against direct solar radiation reflected from its surface, according to claim 1, wherein it can be applied to already existing buildings and by having a metallic sheet skirt, forming the new reflecting slope, which is folded and stiffened on itself, housing an insulation body inside it to which it is attached, as wedge or boss, which is placed on top of the already-existing drip cap, fixed to the opening base and comprising two protruding pins for its mechanical anchoring to both sides of the opening soffit.

4. Drip cap with discharge adaptation to protect building openings and their inside against direct solar radiation reflected from its surface, according to claim 1, wherein it can be applied to a new construction to configure the different drip caps in a heliodynamic way, according to the orientation of the facades.
